(19) United States
(12) Patent Application Publication
(10) Pub. No.: US 2005/0019734 A1
(43) Pub. Date: Jan. 27, 2005

(54) System and method for diagnosis of mental disorders

(76) Inventor: Avi Peled, Binyamina (IL)

Correspondence Address: KATTEN MUCHIN ZAVIS ROSENMAN, 575 MADISON AVENUE, NEW YORK, NY, 10022-2585, US

(21) Appl. No.: 10/496,225

(22) PCT Filed: Oct. 28, 2002
(86) PCT No.: PCT/IL02/00858

Related U.S. Application Data
(60) Provisional application No. 60/331,568, filed on Nov. 20, 2001.

(51) Int. Cl. G09B 19/00

(52) U.S. Cl. 434/236

(57) ABSTRACT

The present invention provides a computerized system for diagnosing a subject's mental state on the basis of subject's behavior, as measured within a framework of virtual reality environments. The system is utilizes fuzzy logic clustering application for creating behavioral-mental profile of the user. The virtual realty environment is designed to measure a specific behavior pattern, which represents a cognitive or physical functionality. The system output is used as basis for formulating a complete mental diagnosis of the examined subject.

### FIELD OF INVENTION

The invention relates to tools for diagnosis of mental disorders and personality traits. More particularly the invention relates to diagnosis tools, which are based on virtual reality environments for non-linear assessment and categorization of functional behavioral profiles of tested subjects.

### BACKGROUND

Currently, psychiatric diagnosis is generally achieved through interviews comprising of a collection of complaints (symptoms), observations regarding appearance behavior and speech (signs), and the history of the symptoms and signs (anamnesis). Interviews are carried out in the clinician's office and information is gathered based on the patient's memory of past events, in a setting that is detached from the natural context of events that influence the patient's distress. The interview setting and the encounter with the psychiatrist influence both the clinical picture as well as apprised information. Unfortunately, the anamnesis, as well as the collection of signs, serves as a basis for creating a diagnosis categorization that has no relevance to any known aspect of the patient's brain function. For example, the diagnosis of schizophrenia is achieved by use of a predetermined consensual-based list of symptoms and signs, rather than through a set of sensory-motor or inter-sensory deficits shortfalls. According to current revelations by neuroscientists, the latter method would do more justice to the etiological basis of this disorder.

Theories of Brain Organization Relevant to this Project

Today the brain is viewed as an interconnected system of integrated neural network ensembles spread in the cortex. Mental functions emerge as computations of dynamic rapid interactions between disparate networks forming ever-changing ensembles of activated neuronal populations. This vision of the brain is not entirely new, as early as 1881 Wernicke regarded the cerebral cortex as constituting, in its anatomical arrangement of fibers and cells, the organ of association (Wernike, 1906). This idea was refined when Donald Hebb (1949) proposed that “two cells or systems that are repeatedly active at the same time will tend to become associated, so that activity in one facilitates activity in the other.”

Associations lead to organization evolving to hierarchical formations of increased neuronal integration. Mesulam (1998) has reviewed the hierarchical brain organization leading from sensation to cognition (See FIG. 10).

Unimodal association areas achieve part of the lower hierarchical organization; they encode basic features of sensation such as color, motion, and form. They process sensory experience such as objects, faces, word-forms, spatial locations and sound sequences. More heteromodal areas in the midtemporal cortex, Wernike's area, the hippocampal-entorhinal complex and the posterior parietal cortex provide critical gateways for transforming perception into recognition, word-formation into meaning, scenes and events into experiences, and spatial locations into targets for exploration. The highest connectionist levels of the hierarchy are occupied by the transmodal, paralimbic and limbic cortices. These bind multiple unimodal and the higher more heteromodal areas into distributed but integrated multimodal representations. The transmodal systems with their complex functional inter-connectivity actualize the higher mental functions (FIG. 1). It is at this level of transmodal connectionist systems that coherent integrated conscious experience emerges. Integrative capacity of transmodal systems are probably responsible for the internal consistency we experience in our mental functions, and why reality is perceived as being coordinated editorially, visually and tactually. Planning, thinking and acting also have consistency; thoughts and reactions are goal-directed to the stimuli at hand, and match situational events. Finally, our entire conscious experience seems united in a complete logical and meaningful continuity. Additionally it is at this level that the “internal model” of the external world, self-notions, and interpersonal psychological experiences are actualized, forming the neurological basis of personality (Peled and Geva 1999).

Since integration and connectedness of neural systems are such critical factors of mental functions, the ability to investigate brain integration was contributed by the work of Gulio Tononi, 1994. He introduced the concept of neural complexity (C_{N}) (Tononi, 1994) as a measurement of the interplay between integration (i.e., functional connectivity) and segregation (i.e., functional specialization of distinct neural subsystems). C_{N} is low for systems whose components are characterized either by total independence or total dependence. C_{N} is high for systems whose components show simultaneous evidence of independence in small subsets, and increasing dependence in subsets of increasing size. Different neural groups are functionally segregated if their activities tend to be statistically independent. Conversely, groups are functionally integrated if they show high degree of statistical dependence. Functional segregation within a neural system is expressed in terms of the relative statistical independence of small subsets of the system, and functional integration is expressed in terms of significant deviations from this statistical independence.

Based on the new approach of the brain organization as a dynamic integrated neuronal system for the computation of high mental functions, mental disorders are viewed as “breakdowns” in neural integration (Peled 1999). For example in schizophrenia it is becoming evident that symptoms such as delusions and hallucinations arise from disturbances of coordination among the activities of distributed neural networks in the brain. With advanced imaging studies of schizophrenic patients (Friston & Frith, 1995; Friston 1996; McGuire, 1996). The “disconnection syndrome” for schizophrenia proposed by Karl J Friston (1995) suggests that different neuronal systems become disconnected from each other. He uses the term “effective functional connectivity” to describe neuronal associations; it is the influence that the activity in one neuronal system has on the activity of the other neuronal system. Recently Giulio Tononi (2000) has also reviewed evidence of disconnectivity in schizophrenia. Tononi proposed that disruption of re-entrant interactions among cortical areas, as well as thalamocortical integration and alteration of diffuse ascending neural systems contribute to the pathophysiology of schizophrenia (Tononi et al 2000).

If schizophrenia represents one of the more severe mental disorders that exist in psychiatry, personality disorders reflect a more mild set of disturbances. Interaction between certain personality traits and specific psychosocial events can generate a wide range of mental disturbances (e.g., depression and anxiety). Personality traits are conceptualized as enduring patterns of perceiving, relating to, and thinking about the environment and oneself. They are exhibited in a wide range of social and personal contexts (Sadock, 1989). Object relation psychology states that personality is shaped by a set of internal representations in the brain that dynamically change tapping the history of the entire psychosocial life experiences of the individual.

The idea of internal representations acting as “maps” that evaluate and shape experience has been previously described by other authors. According to Rogers, organizmic evaluation is the mechanism by which a “map” (i.e., the internal configuration) of the experiential field assesses the psychological events of everyday life (Rogers, 1965). Internal maps of dynamic adaptive configurations have been described in the brain at multiple levels for example, the “homunculus” a sensory cortical representation of body surface. Neural network models that simulate brain architecture and neuronal function have also provided evidence on possible representations emerging from their connectionist power and self-organization (Peledand Geva 1999). Thus it is conceivable that the brain sustains a map of internal representations that is continuously updated through interactions with the environment (Peled 1999).

Recently this type of interaction between internal representations and perception of environmental stimuli has been referred to as context-sensitive processes (Friston, 1998). Due to this interaction, internal representations can be viewed as approximated models of reality. It is reasonable to assume that a “good match” between internal representations (of the psychosocial world) and external psychosocial situations will enable efficient adaptive interpersonal relationships. On the other hand, a “mismatch” between the psychosocial events of the real world and their internal representation may “deform” the perception as well as the individual's behavioral responses. In addition, reduced matching complexity (Tononi 1996) will further reduce adaptability causing rigidity, reducing the repertoire of reactions available to the individual.

To summarize, it is evident from modem brain research that the brain is essentially a hierarchical organization of neuronal ensembles and networks. Integration and segregation play a dynamic role in representing and computing mental functions. Hierarchical integration is important for higher mental functions such as working memory and for those mental functions necessary for effective adaptive interaction with the environment. Internal representations formed from the connectionist power of the brain systems provide for the internal model of the psychosocial world that shape psychological emotional experience and its personality correlate of behavior. These insights serve for the construction of a novel diagnostic system explained below.

Microprocessor-Based Interactive Virtual Environment for the Evaluation of Mental Functions

Virtual reality (VR) is a set of computer technologies which when combined, provide an interface to a computer-generated world, and in particular, provide such a convincing interface that the user imagines he/she is actually in a three dimensional computer-generated environment (experience that is also termed “presence”). A key feature of virtual reality is interaction. The computer program responds to commands as to enable the subject to act and react participating in the computer-generated environment. The HMD is a helmet or a face mask that holds the visual and auditory displays. Most HMDs use two displays and can provide stereoscopic imaging. The HMD also requires a position tracker to enable the effect of eye tracking and head rotation in the exploration of the virtual environment. The audio component of the HMD provides the relevant sounds generated by the virtual environment. To enhance the auditory virtual sensation, a so-called “head relevant transfer function (HRTF)” program provides for a 3D sound recognition. The DG is a special glove instrumented to manipulate objects in the virtual environment. This glove is equipped with sensors for finger bends and magnetic trackers for overall position, which are used to project real hand movements into the artificial environment. Haptic Rendering (HR) is the generation of touch and force feedback information.

The use of VR technology in psychiatry is currently directed especially to the treatment of anxiety disorders such as phobias (e.g., fear of height flights and insects; loom 1997; Bullinger et al 1998; North et al 1998; Baltzel 1999; Rothbasum et al 1998; 1999) where the virtual experience is modeled for desensitization therapy. In anorexia nervosa body image can be projected into the virtual world for feedback of body dimensions (Riva et al 1998). Also interesting is the work on bedside wellness system (BWS) in which creation of pleasing environment for bedridden oncology patients has improved their reaction to treatment and their coping capabilities (Oyama et al 2000). VR technology has also been applied to cognitive assessments and rehabilitation in neurological disease such as traumatic brain injuries (Christiansen et al 1998; Lewis 1998; Strickland 1997; Latash 1998).

Specifically relevant to this work are the insights obtained from cognitive assessment with VR technology (Rizzo 1999). Traditional neuropsychological testing methods are limited to measurements of specific theoretically predetermined functions such as short-term memory or spatial orientation. Given the need to administer these tests in controlled environments, they are often highly contrived and lack ecological validity or any direct translation to everyday functioning (Neisser 1978; Rizzo 1999). VR technology enables subjects to be immersed in complex environments that simulate real world events, which challenge mental functions more ecologically. Existing neuropsychological tests obviously measure some brain mediated behavior related to the ability to perform in an “everyday” functional environment. However, VR could allow for cognition to be tested in situations that are ecologically valid. While quantification of results in traditional testing is restricted to predetermined cognitive dimensions, many more aspects of the subjects' responses could be quantified using VR technology. Information on latency, solution strategy and visual field preferences, etc. could be quantified. VR can immerse subjects in situations where complex responses are required and measure all responses in this environment (Rizzo 1999).

To summarize, VR technology for neuropsychological testing provides numerous advantages over traditional techniques. These advantages are: the presentation of ecologically valid testing scenarios and cognitive challenges that are difficult to present using other means, total control over stimuli delivery, and a capacity for complete performance recording. Additionally, repetitive stimulus challenge could be easily varied from simple to complex, contingent upon success, and the “gaming” factors of such challenges enhance motivation. Finally these VR technology methods provide low cost challenging environments, in terms of time and funds, which could be applied from any fixed location of laboratory or office.

Although promising, many problems are yet to be solved in regard to VR technology in cognitive testing. Most importantly it will need to be determined if the brain reacts to virtual environments in a manner similar to physical environments.

This is the question of “generalization” in training with virtual environments. Is the obtained skill from training in the virtual environment valid in real world situation? Although those experienced in flight simulators argue for good generalization with VR technology, as for cognitive testing more specific validation will be required. Many problems in data management and analysis also remain to be solved. The availability of such comprehensive and discrete data is one of the most intriguing aspects of VR. However, it poses the possibility of “drowning” in ones' data. Finally a few side effects have been described which can limit the use of this technology for certain individuals. Some patients complain of dizziness, nausea, and vomiting as a reaction to the use of VR, a condition referred to as “cibersickness”. These symptoms probably originate from vestibular discrepancy between the occurrences in the virtual environments and the real world gravitation. Visual blurring and stressing are additional side effects to be considered, especially in long trials of testing environments.

Classification of patients' mental conditions using fuzzy logic principles has already been proposed: U.S. Pat. No. 5,788,640 discloses a method which classifies stress test data using a processor for comparing the current stress level with previous stress test data grouped in fuzzy sets, and for generating a classification of the current stress test data with respect to the fuzzy sets.

Additionally, interactive computerized techniques have been proposed in the prior art for treating and measuring mental ability in general, and schizophrenia in particular:

U.S. Pat. No. 5,911,581 discloses an interactive automatic system and technique for measuring and the training of mental ability. The invention is implemented on a computer that automatically presents a variety of visual and auditory stimuli. The system then measures reactions to the stimuli, adjusts certain stimulus parameters, and provides scores in response thereto. The scores are tabulated and displayed for analysis. In particular embodiments, the invention tests for physical reaction time, perceptual awareness thresholds, attention level, speed, efficiency and capacity of information processing by the brain, and elementary cognitive processes including memory, memory access and decision-making speed.

The invention measures, identifies and quantifies noise in the subject's brain and elementary cognitive processing system, and the information exchange rate between the subject's left and right brain hemispheres. The inventive system compiles a history of the test scores, renders an overall performance rating, and delivers comments based on the subject's scores. The complexity of the tests is adjusted based on the scores to optimally challenge cognitive capacities, thereby rendering more accurate evaluations of cognitive capacity, and optimizing learning of desired improvements in perceptual, physical and mental response speeds and efficiencies.

Other inventions have suggested the use of virtual reality technology in computer systems in treating psychiatric patients.

U.S. Pat. No. 6,012,926, and 5,807,114 disclose a virtual reality system that provides effective exposure treatment for psychiatric patients suffering from a particular anxiety disorder. The system is characterized by a video screen disposed in front of the patient to display an image of a specific graphical environment that is intended to trigger anxiety within the patient as a result of the particular patient's phobia. A headset is worn by the patient, and has sensors disposed to detect movement and positioning of the patient's head. A computer program controls the operation of the system, and is designed to control the display of the graphical environment on the video screen, monitor the headset sensors and determine the position of the patient's head, and controllably manipulate the graphical environment displayed on the video screen to reflect the movement and position of the patient's head.

A sensor is provided to automatically detect the level of patient anxiety, and the computer program is designed to monitor this sensor and controllably manipulate the graphical environment displayed on the video screen in response thereto. In other embodiments, sound and tactile feedback are provided to further enhance the graphic emulation.

Although prior art inventions suggest the use of virtual reality technology in treating psychiatric patients, none of these techniques is designed to generate a diagnosis, which can then be directed towards identifying disturbances of brain organizational capabilities.

The present invention suggests the use of virtual reality technology in creating challenging ecological interactive environments, which will then be presented to treated patients as an exam. The tested patient will interact with the challenging and psychosocial events in the virtual environments and his/her reactions will be quantified and stored to form the database of his/her diagnostic profile.

### SUMMARY

The present invention provides a challenging VE (Virtual Environment) that would enable the production of a comprehensive functional as well as behavioral profile of the investigated subject or patient. Virtual reality technology (VRT) offers the opportunity not only to create highly controlled and interactive virtual conditions, but also to sample and monitor online all the responses, decisions, and interactions that are effectuated by the investigated subject.

This project proposes to diagnose mental disorders by monitoring patients' immediate functions within carefully and relevantly designed challenging Virtual Environments, and to interpret his/her deficit with the aid of an unsupervised fuzzy logic algorithm for a more etiologically (that is, relating to the causes of the disease) based disease interpretation.

### BRIEF DESCRIPTION OF THE DRAWINGS

These and further features and advantages of the invention will become more clearly understood in the light of the ensuing description of a preferred embodiment thereof, given by way of example only, with reference to the accompanying drawings, wherein

FIG. 1 is a general diagrammatic representation of the environment in which the present invention is practiced;

FIG. 2 is a block diagram of the diagnostic computerized device according to the present invention;

FIG. 3 is a diagram illustrating the relations between FMP modules according to the present invention;

FIG. 4 is a chart illustrating the relations between FMP module and mental states;

FIGS. 5a and 5b are tables exemplifying possible virtual reality scenarios according to the present invention;

FIG. 6 is a flow-chart illustrating the virtual reality environment activity process according to the present invention;

FIG. 7 is a flow-chart illustrating the session results processing according to the present invention;

FIG. 8 is a flow-chart illustrating the process comparing profiles according to the present invention;

FIG. 9 exemplifies the possible diagnostic presentation according to the present invention;

FIGS. 10 and 11 presents the hierarchical organization of the brain as a centrifugal arrangement from transmodal to more unimodal systems and regions;

### DETAILED DESCRIPTION OF THE PREFERRED EMBODIMENTS

The main concept of the present invention is to use virtual reality tools for measuring and diagnosing a subject's reactions at different levels of behaviors, which represent the brain's different activities and functionalities. This analysis of the subject behavior is clustered into profiles representing mental state categories. Its is assumed that the measured and analyzed behavior can be interpreted as a dysfunction in one or more brain activities or functionalities or luck of connectivity within the brain neural networks.

The present invention provides a set of tests, implemented as virtual reality scenarios, wherein each test relates to one or more subject's physical and/or cognitive capabilities. The tests are performed according to a predefined order relative to their difficulty level. This set of tests is specially designed to enable differentiation between different functionalities and activities of the brain neural network hierarchical processing.

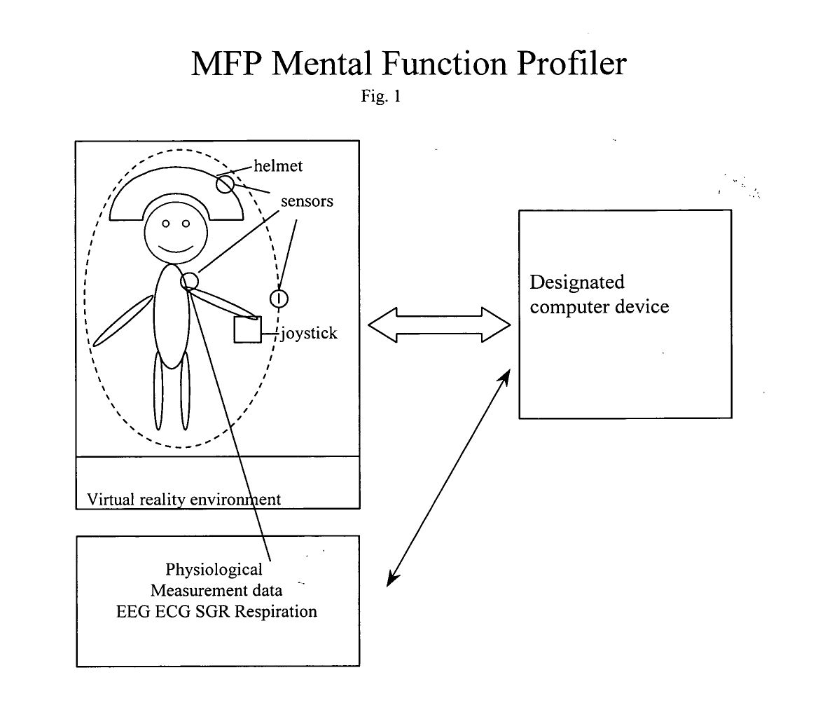

According to the present invention, it is suggested to use fuzzy logic methodologies for clustering the test results, wherein such a clustering process serves as a decision supporting tool for diagnosing the subject mental state. FIG. 1 illustrates a general scheme of the environment in which the present invention is practiced. The subject is equipped with virtual reality interfaces, which basically include a head mounted display, navigation device, and several sensors, all of which are connected to a computerized device programmed to activate, control and monitor the virtual reality environment. The computer device includes a designated software application system for data processing and analyzing the virtual reality test results. Optionally the subject is connected to physiological sensors, which provide measurements to respective physiological monitoring machine such as EEG, ECG, SGR etc.

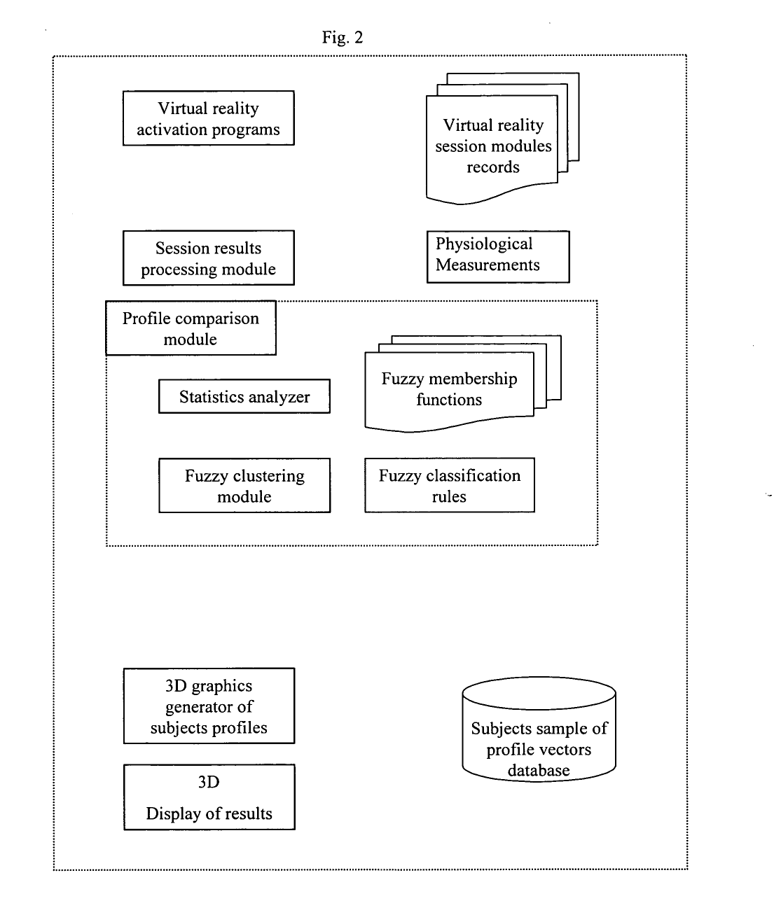

FIG. 2 is a block diagram of the computerized device software modules. The first module is responsible for activating the virtual reality scenes and operating the interactive programs of the different tests, which respond to subject behavior. This module retrieves the different scene sessions from the virtual reality scene database. The second module is responsible for communicating with virtual reality output interfaces and receiving all data of subject behavior as detected by the various sensor units. The module processes and analyzes the received data to be recorded in designated data formats.

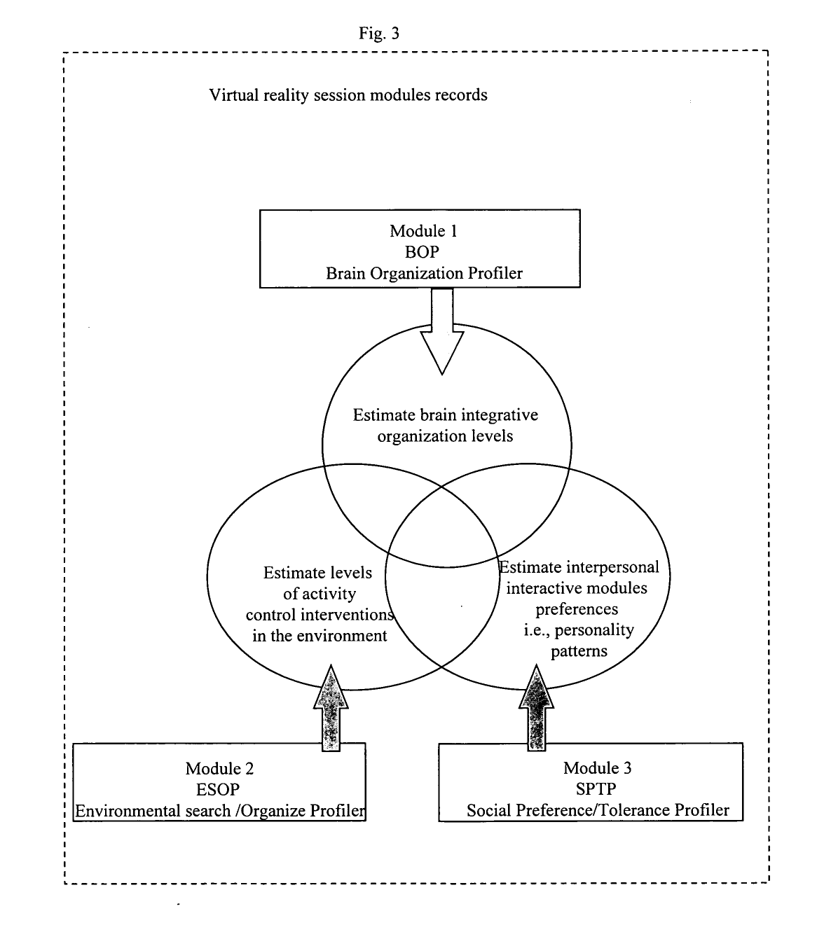

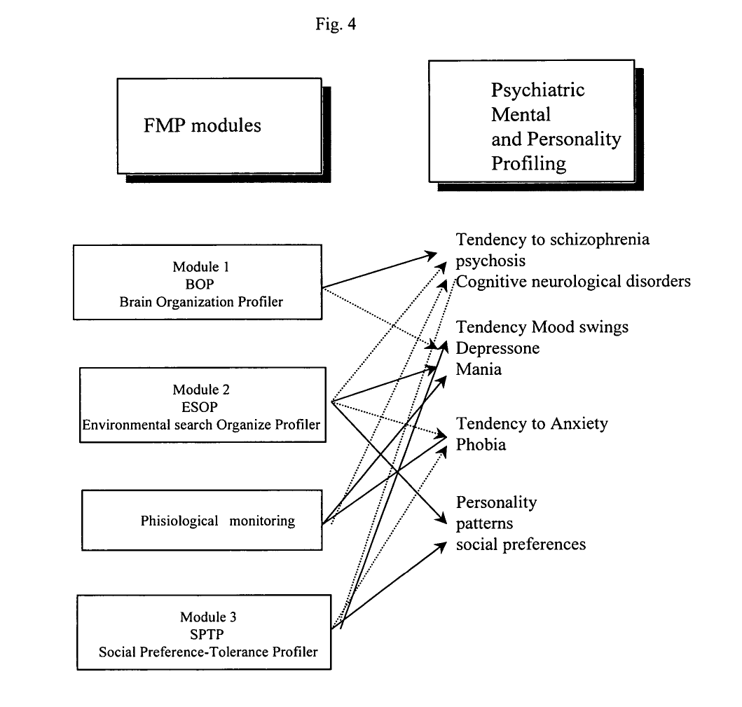

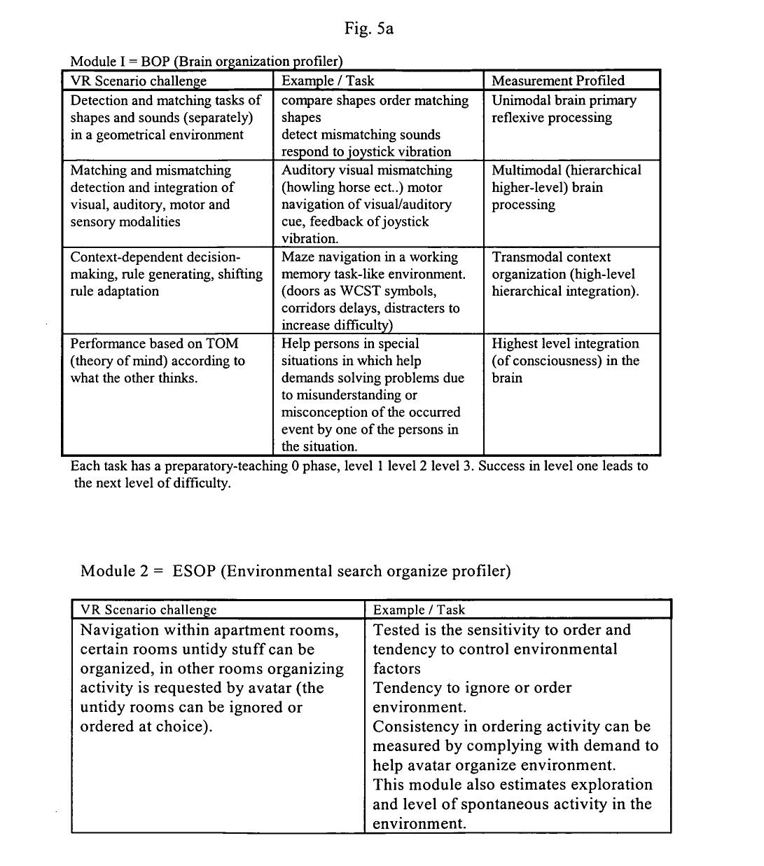

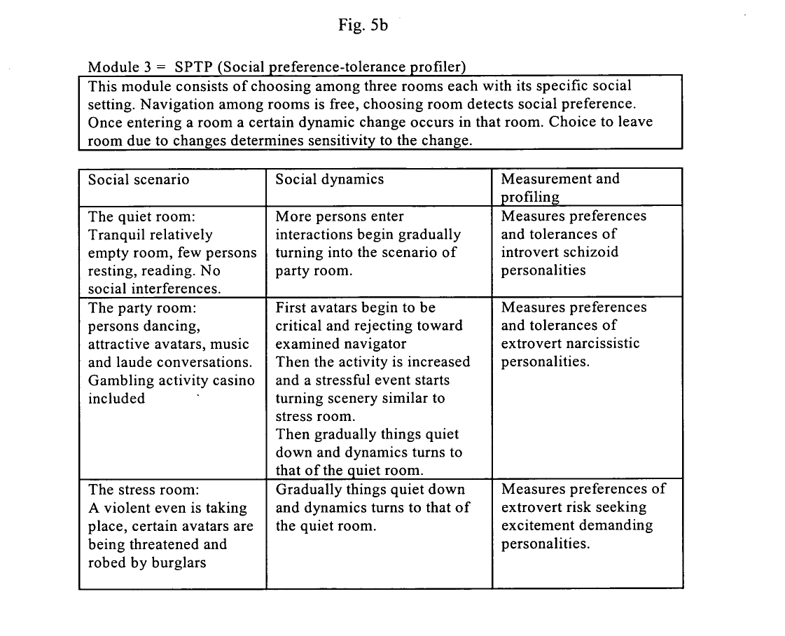

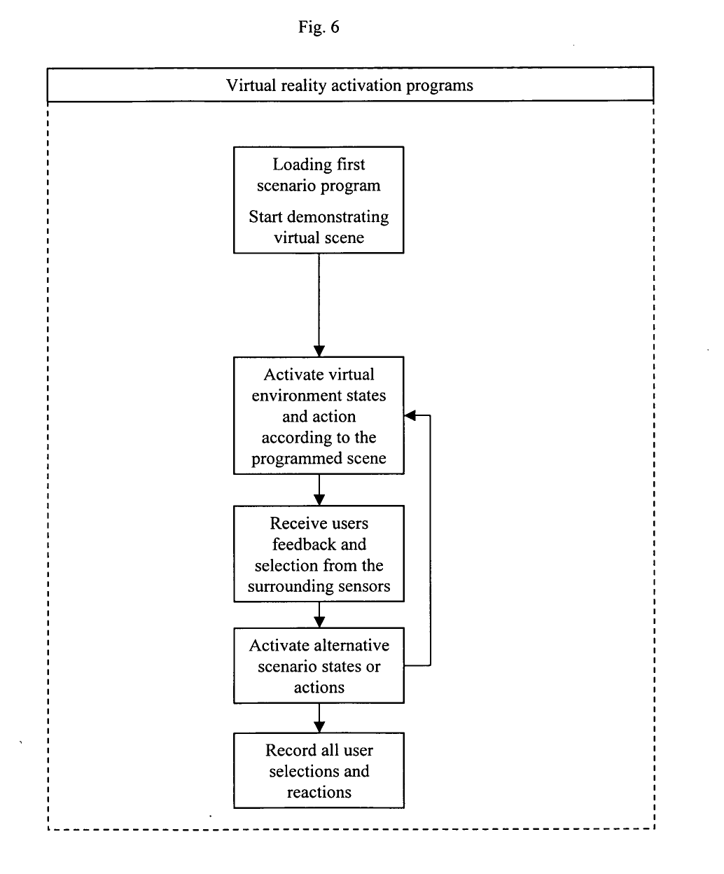

The measured behavior and analysis for each test are related to different diagnostic modules of the brain. The brain modules are described in FIG. 3. The first Module is the brain organization profiler (BOP), which is used to estimate brain integrative organization level. The BOP module analysis is based on measuring sensor-motor behavior of the subject in different hierarchical levels of the brain functionalities. The second module is the Environmental Search Organize Profiler (ESOP), which is used to estimate activity levels and control intervention in the environment. The ESOP module analysis is based on measuring the subject's sensitivity to order and tendency to control the surrounding environmental factors e.g. organizing untidy room. The third model is a social preference tolerance profile, used to estimate interpersonal interactive behavior. This module is based on testing the subject behavior in different social scenarios. FIG. 4 table includes a detailed 15 description of virtual reality scenarios used to measure the different parameters in each diagnostic module. Each scenario exemplifies possible tests and related tasks for measuring the different brain activities and functionalities. The categorization of the tests and gradual complexity order of the tests facilitates the identification and diagnosis of the subject's personality and behavioral profile.

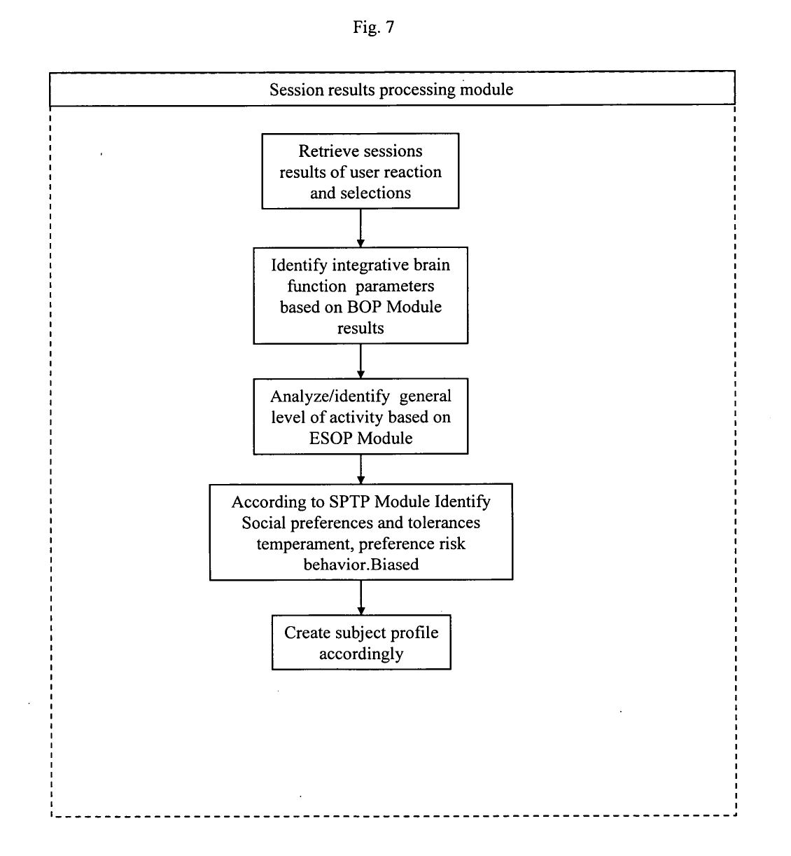

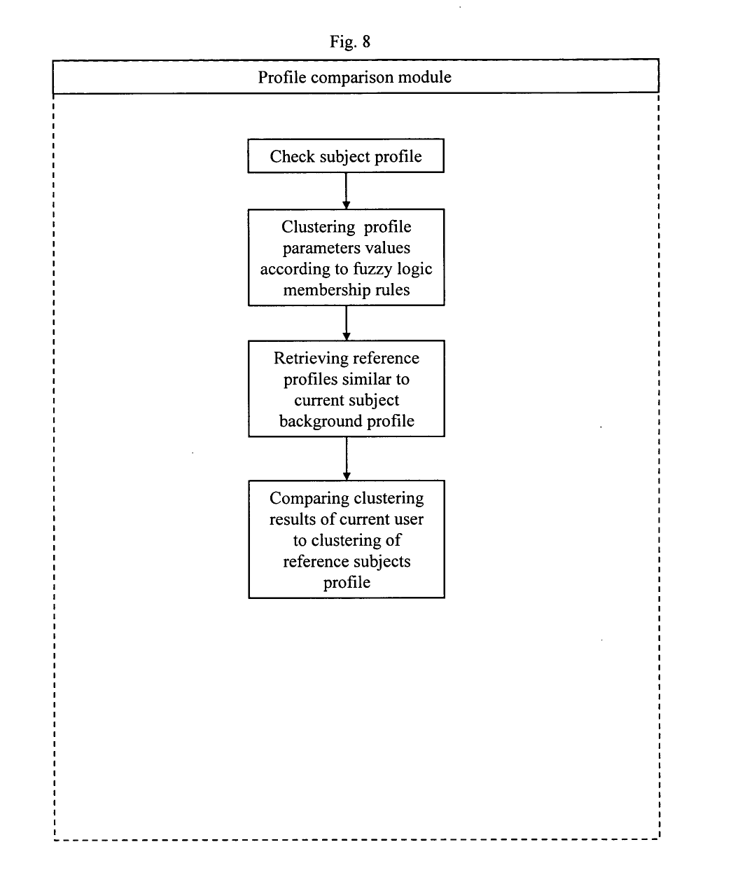

The measurement results of each scenario test are first manipulated and converted to correspond with predefined parameter scales, and then categorized according to the different brain modules and measurement profiles. The categorization process is detailed in the flowchart of FIG. 7.

The formatted data results are now subjected to clustering analysis, performed by the profile comparison module according to fuzzy logic methodologies.

The fuzzy logic system comprises fuzzy sets, wherein each set defines specific characteristics that reflect the subject's mental states. FIG. 4 illustrates examples of subject characteristics and their relation to brain functional modules. For example, one set of fuzzy rules defines the subject's tendency to schizophrenia psychosis. The final result is expressed in terms of values within a range of two extremes. This value is calculated as a function of a set of fuzzy rules, wherein each rule checks the value of specific measurement. These measurement results are associated to the fuzzy sets according to predetermined relations as illustrated in FIG. 4. For example the subject's tendency to schizophrenia psychosis is most influenced by measurements of the BOP model and SPTP module and partly affected by the ESPO model measurements or Physiological monitoring. The fuzzy rules determine the logic relations between the measurement result value and the fuzzy set's final results. These rules are determined according to theoretical assumptions of the human behavior, brain neural connectivity and functionality, and statistics analysis based on reference measurements of subject behavior and the diagnostic results.

As human behavior and brain functions are predicted to act in a non-linear fashion, it is presumed that behavioral/functional subject profiles would occupy a hard-to-classify, spectrum-like, multi-dimensional space. A novel psychiatric diagnostic categorization can be achieved using unsupervised fuzzy clustering (UFC); a technique specially suited to solve problems of hard-to-classify, multi-dimensional spaces. Moreover UFC does not involve any predetermined constraints on the parameters of profile classification, enabling a self-organizing, natural clustering of the different profiles. It is predicted that the UFC classification would reflect upon the common behavioral/functional deficits that would characterize all subjects classified to that cluster. In this manner, classification clusters would represent specific brain disturbances and provide for a more etiological-based (cause-based) psychiatric diagnosis as opposed to descriptive non-etiologic diagnosis of current science. This phase of the tool development would warrant an extensive epidemiological study.

Finally it is predicted that the different deficits presented within the different clusters would map onto a necessary framework of brain function. A good example of such framework is provided by Mesulam (1989) and Fuster (1998) in their respective comprehensive works detailing brain organization (see below).

An additional feature of the present invention is a visual graphic presentation as output of the diagnostic profiles. A multidimensional projection graph displays the following dimensions: 1) Integrative brain functions (game results of phase I), 2) general level of activity, 3) Goal and pleasure directness of activity, 4) temperament preferences, risk behaviors, and attraction rejection reaction modes (rooms navigation choices), 5) frustration levels and tolerances.

The diagnostic profiles are further projected onto and compared to the reference classification system of mental disorders in order to obtain a full diagnosis analysis.

The following is a depiction of possible virtual environment scenarios presented to a subject:

The Neighbors' Party: a Challenging Virtual Environment

The subject begins his virtual experience by receiving an invitation to the neighbors' party. The invitation states all the tempting events that should take place once the subject enters their home. To enter the house the subjects needs to pass a set of games, which will finally lead him into the house. Thus the activity of the subject in the virtual environment is divided into two phases; the first phase involves the subject's activity during the introductory set of “games,” and the second phase involves his/her activity within the house. Once in the house the subject is presented with a map of rooms and backyards with their corresponding activity. The subject is shown which activity takes place in each one of the locations within the house. The subject can then choose according to his preferences into which room or location to enter. During this second phase the subject is allowed to journey through the rooms, and within each room he will interact with the specific psychosocial events that will characterize that room. In a last complementary sub-phase of the second phase the subject is forced to enter certain chosen rooms in order to examine his reaction patterns to the events in that room.

In the first phase the games are designed to test cognitive mental functions. For example a ping-pong game may test for immediate reflexive sensory-motor coordination, and a planning puzzle-like construction games may test for a higher-level integrative sensory-motor abilities. A game that involves matching sound-to-vision could evaluate the auditory-visual integration; for example playing a mismatch detection game in which visual stimuli that do not match are detected (i.e., mooing dog, beating guitar). A more sophisticated mismatch detection game could involve a speaking face with mismatch of sound-to-lips-motion variability.

Abstraction and categorization game (order things according to their category) could involve a more integrative transmodal organization. Finally, a maze based on a Wisconsin-card-like method, with doors and arrows that direct the subject to arrive at the house, estimate the working memory capabilities of the tested subject. Difficulty could increase with longer delays (e.g., longer corridors) and distractions (i.e., additional signs and events). The table in FIG. 2 shows the various tests and their administration with increasing difficulty to evaluate subject capacities in phase one of the Virtual Environment.

In the second phase of the Virtual Environment, the house contains eight locations from which to choose, ranging from a quiet relaxing solitude backyard to a violent aggressive event of assault taking place in one of the bedrooms. Locations in-between these two extremes involve social events of people conversing or presenting, working events related to household and party events with pleasurable romantic interpersonal potentials. The events in each room will be computed to follow an algorithm of favorable-versus-unfavorable course. In other words, in each room the interactions of the subject relevant to this room will gradually become unfavorable. For example, in the room of interpersonal conversation the subject will initially be accepted with positive feedback and admiration from fellow persons, but gradually this attitude will change and become criticizing, non-accepting, and even hostile. At the room in which there is a party and romance, initially the subject will have the upper hand and success with his attempts to find a match for dance. Gradually, conditions will worsen and he might encounter refusals and even insults.

The rooms are as follows: 1) A quiet backyard with nothing to do but relax. 2) A room being cleaned and organized by a servant asking for your help with chores. 3) Fixing a car in the garage, more demanding work. 4) Living room with other people conversing and chatting. 5) A larger room presenting talking in front of audiences. 6) Party room and disco. 7) Gambling room where one can win and lose money. 8) Bedroom where a violent aggressive event of assault is taking place.

The type of psychosocial interaction, number of interactions, duration of engagement, degree of frustration and endurance all are collected via the computer program in each of the events typical to each room. If rooms are being avoided then at the last sub-phase after the subject was free to visit any room, he will be forced to enter the remaining rooms and his interactions within those rooms will be sampled.

In summary, a virtual environment includes an invitation to the neighbors' party. Going to that party is divided into two major phases. The first phase, i) is where the subject must enter the home, a task that involves a set of games designed to challenge major high mental functions. Once in the house, the second phase ii) involves interacting with the various occurrences in different rooms. Each room includes its own specially designed set of events. A preliminary Virtual Environment model is detailed in the appendix, the development of EMF Systems could emerge from this rudimental model.

The results obtained from the above mention party scenario are analyzed according to the methodologies of the present invention as described above. The following paragraph is a detailed explanation of such analysis.

Every parameter of the interaction with the VE is potentially sampled and registered. The navigation and choices of the subject in the VE is documented and stored. The reaction time and number of choices is recorded and stored. Levels of activity and efficacy on the test games are also registered. The database is then available for online computation, generating a personal profile for each tested subject.

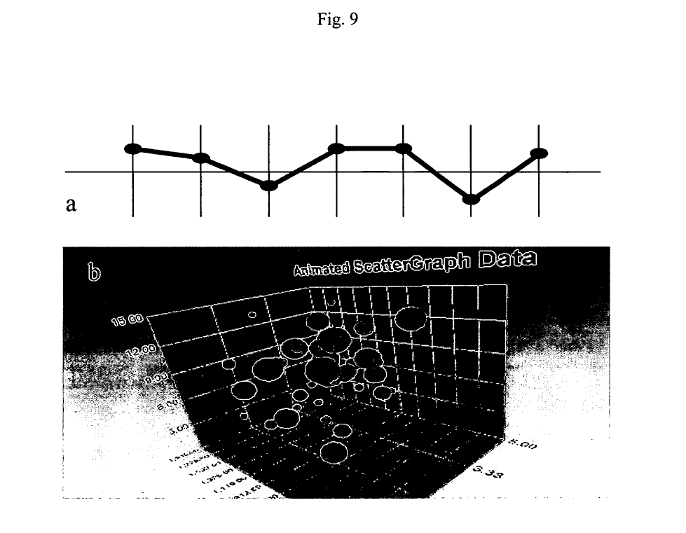

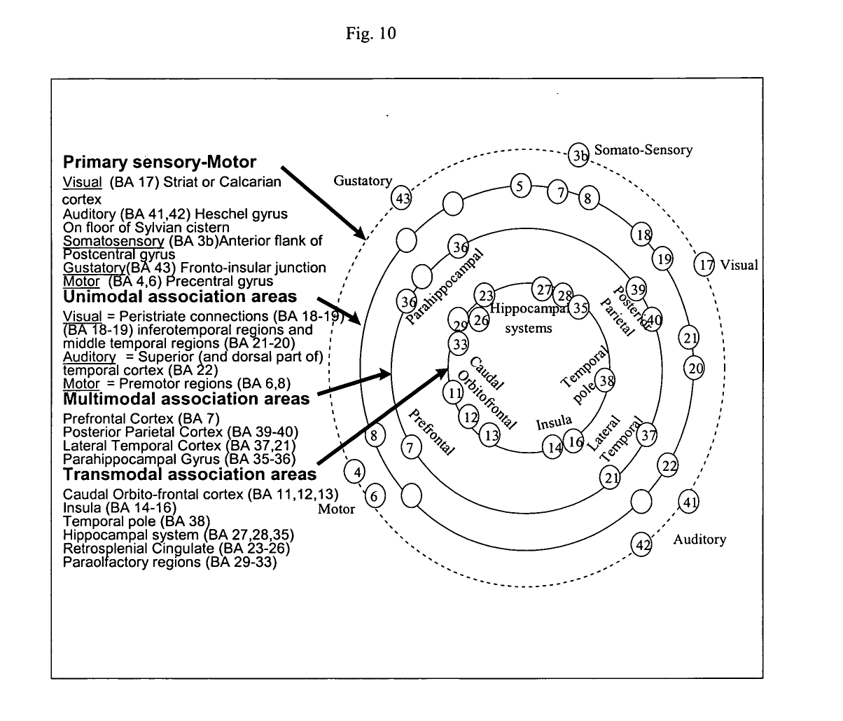

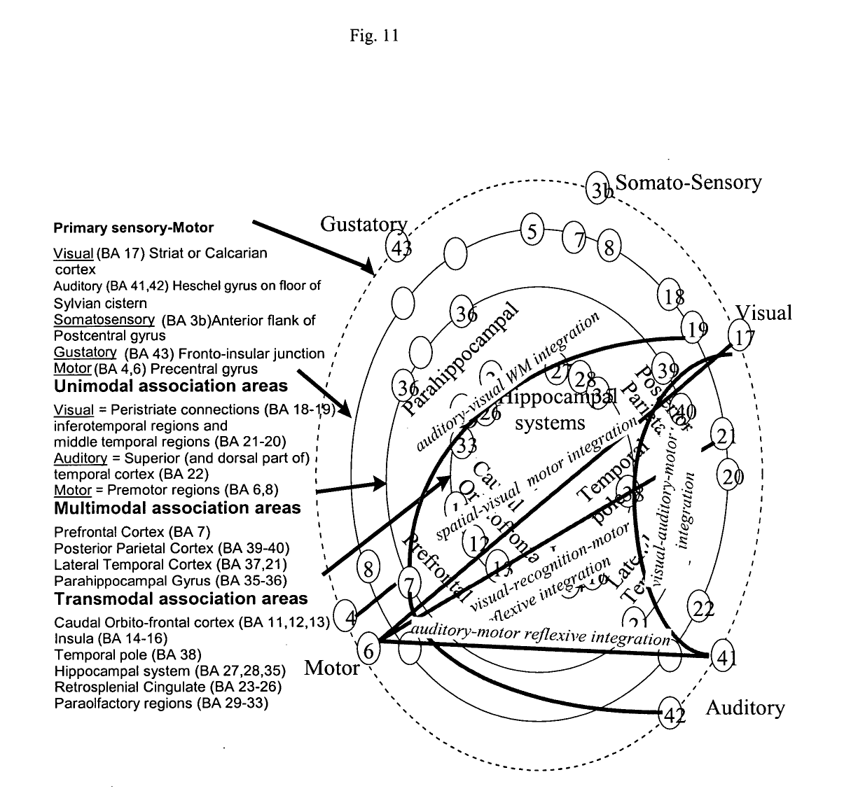

The data is presented in two distinct modes, which enable easy visualization of the results to the clinician. First, the data is presented as a simple graphed vector profile (see FIG. 9a) and then as a multidimensional projection graph (see FIG. 9b).

The vector profile enables a detailed evaluation of the following dimensions: 1) Integrative brain functions (game results of phase 1), 2) general level of activity, 3) goal and pleasure directness of activity, 4) temperament preferences, risk behaviors, and attraction rejection reaction modes (rooms navigation choices), and 5) frustration levels and tolerances. The multi-dimensional projection of the data allows for easy visualization of multiple cognitive factors. The visualization is also relevant for follow-up and monitoring response to treatment protocols. A point of one evaluation in recurrent evaluations enables a trajectory that allows for visual representation of the progression of the disorder.

Comparing the data of the individual subject with the background of a general population of patients and normal controls enables the clustering of different profiles. Since data measurements presumably overlap due to complex nonlinear origins, fuzzy logic and unsupervised neural-network-based computation will be used for classification and data analysis (see details of clustering algorithm below: “Unsupervised Fuzzy K-Mean and PCA”). Such classification and clustering techniques will eventually form a new classification system for psychiatric disorders.

The individual subject can then be classified as certain general disturbances found in the general population sample. The different clusters could be named after their system characteristics, thus reflecting a more plausible, etiological nomenclature for psychiatric diagnosis. For example, subjects may classify for low multimodal integration level or reduction of sensory motor integration, substituting the stigmatizing terminology of psychosis and schizophrenia.

Appendix:

Rudimental VE model for EMF Systems

PART 1 The maze

Scenarios

The virtual journey begins when the subject enters a room with three doors each door presents a button to press. Buttons have the shapes of a circle square and triangle and have different colors. Pressing the button can give three different bell-noises, a squeak high pitch noise, a regular bell noise, and a buzzing mechanical noise. Only the door with a red button and bell noise opens (shape is not important since all red shapes respond). In this case the rule to follow is Red+ Bell+ all shapes. (Sound is effectuated nearing bell before pressing).

Once opened the door leads to a corridor that reaches another room. The same rule follows.

After 10 consecutive rooms, the rule changes. For example, only the square squeaking buttons (no matter which color) open doors (i.e., the rule has changed to Square+ Squeaking+ all colors).

As performance progresses, difficulty of task increases by prolonging responses and increasing delays. This is achieved in two ways: doors open slowly, or corridors become longer. As performance progresses, distractions are added in the form of avatars walking the corridors. Avatar distracters increase as difficulty of task increases.

Background vocal commands go or stop can appear warranting the subject to obey the command.

Professor avatar/music appears when a specific avatar (titled the professor because he wears the special academic custom hat and frock not presented by any other avatar) appears in conjunction with a specific short tune of music. The appearance of the correct professor-avatar/music event warrants a special greeting performed by pressing joystick button.

Task Difficulty Algorithm

Task difficulty increases according to the performance of the subject, thus depends on feedback of performance on the previous level. Good performance on a certain stage shortens that stage; vice-versa, poor performance prolongs stage to allow learning training improvement. If improvement is not achieved after 20 minutes of task this first phase terminates and the second phase commences. Four difficulty levels are defined:
1. Easy: empty corridors, fast doors, short corridors (i.e., short delays). Professor avatar/music appears once
2. Regular: spars avatars passing silently, slower doors, longer corridors (i.e., longer delays). Professor avatar/music appears occasionally
3. Hard: many avatars (silent) some bumping into subject, slow doors, long corridors. Professor avatar/music appears frequently
4. Tough: crowded with avatars talking to and bumping into the subject, along long corridors and slowly moving elevators. Professor avatar/music appears all the time.
   Joystick Sampling (or HMD Navigation Sampling)
1. Navigation: Center stop position=0, Forward movement=1, Backward movement=2, Left movement=3, Right movement=4 (head turning and strip walking or stopping on the HMD version)
2. Choosing: pressing joystick for choices of button pressing=5, (preferably a glove-like device)
3. Pressing joystick for avoiding avatar distracters=6
4. Auditory command stop, go=7
5. Professor avatar/music appearance=8
6. Choices follow-ups: Errors=0 corrects=1.

[Navigation to a wrong direction for example wrong left=3, 0, correct right=4,1. Each miss of pressing joystick choices is sampled 5, 0 each hit of pressing joystick choices is sampled 5, 1. Bumping into distracters=6, 0 avoiding distracters 6, 1. Not complying with auditory command=7, 0. Obeying auditory command=7,1. Greeting professor correctly (conjunction with correct music)=8,1. Missing professor or pressing when music non-match appears=8,0.]

Performance Indexes.

Navigation rates: (spatial-visual-motor integration): correct versus incorrect percentage of movement. In each difficulty level

Auditory obedience rate: (auditory-motor reflexive integration): obedience versus on-obedience to auditory command rates.

Avoiding distracters: (visual-recognition-motor reflexive integration): bumping into avatars versus avoiding avatars rates in each difficulty level.

Interacting with professor-avatar/music: (visual-auditory integration): Integrating the correct figure with the correct music tones.

Opening doors performance rates: (auditory-visual WM integration). Correct versus incorrect hits. In each difficulty level

Over-all performance score: time spent on each level (success shortens time spent on level) and level achieved.

Assessment of Performance

Subjects could be rated on overall level of performance, more important subjects failures could be broken-dawn to categories according to the parameters attributing to the deficiency in performance. For example, one subject could perform badly because he bumped into avatars, despite having correct hits on door apertures, in this case the failure could be attributed to deficient visual-motor reflexive integration rather then inadequate auditory-visual WM integration. Results are interpreted in a twofold, combined manner. First subject performance profiles are subject to unsupervised fuzzy clustering processes to see if failures really cluster to subentries. These sub-entities are then mapped on to a brain schematic map according to mesulam (see FIGS. 1 and 2)

1. A method for diagnosing subject mental state on the basis of the subject's behavior, as measured within a framework of virtual reality environments, using a designated fuzzy logic clustering application wherein the fuzzy sets represent characteristics of subject mental state and the predetermined fuzzy rules represent correlations between human behavior and human mental state, wherein said correlation is based on hierarchical brain structure connectivity functionality model, said method comprising the steps of:
A. Presenting the subject with virtual scenarios, wherein each scenario is designed to measure a specific behavior pattern which represents a cognitive or physical functionality;
B. Measuring user reactions to displayed scenarios and recording thereof;
C. Classifying recorded measurements in relation to tested behavior according to predefined categories of the fuzzy logic application;
D. Translating measurement results values into fuzzy logic parameters scales;
E. Calculating fuzzy sets values by applying the fuzzy rules on the measured parameters;
F. Creating diagnostic profiles of the subject based on the fuzzy logic output results;

2. The method of claim 1 wherein the virtual scenarios check cognitive and mental functions by testing sensor-motor abilities in various levels;

3. The method of claim 2 wherein the sensor-motor levels include immediate sensory-motor coordination (such as a ping-pong game), integrative sensor-motor ability (such as a maze game) or auditory-visual integration (such as an audio-visual matching game).

4. The method of claim 1 wherein the virtual scenarios include environmental organization tests for estimating the subject's sensitivity to order;

5. The method of claim 1 wherein the virtual scenarios include interpersonal behavior tests for assessing subject behavior within social activities, wherein each social activity measures a different level of social interaction;

6. The method of claim 5 wherein the social virtual scenarios include a virtual house containing various kinds of rooms, wherein in each room a different type of specific psychosocial event is taking place, and the subject can choose between the rooms and take part in the social activity;

7. The method of claim 6 wherein the psychosocial event gradually changes from a pleasant and accepting environment to a less agreeable and hostile one.

8. The method of claim 5 wherein the subject is forced to take part in one of the rooms' social activity.

9. The method of claim 1 wherein the virtual scenarios include a combination of sensor-motor behavior tests, environment organization tests for estimating subject sensitivity to order, and interpersonal behavior tests for assessing subject behavior.

10. The method of claim 1 further comprising the step of measuring various physiological conditions (state) of the subject;

11. The method of claim 1 wherein the measurement results are manipulated and converted to correspond with predefined parameters scales.

12. The method of claim 1 further comprising the step of creating visual presentation graph of the created diagnosis profiles;

13. The method of claim 1 wherein the visual presentation graph is multi-dimensional, wherein one dimension represents integrative brain functionality, a second dimension represents general level of activity, a third dimension represents general level of activity, a fourth dimension represents risk behavior and attraction/rejection modes, and a fifth dimension represents frustration levels and tolerance;

14. The method of claim 1 further comprising of the step of comparing the diagnostics profiles to reference profiles of specific mental disorders;

15. The method of claim 10 wherein reference profiles are deduced from statistical analysis of the subject's historic profiles and final/actual diagnostics.

16. A system for diagnosing a subject's mental state on the basis of subject's behavior, as measured within a framework of virtual reality environments, said system comprising of:
A. Virtual reality equipment enabling to create audio-visual virtual reality scenes;
B. Database of virtual reality scenes wherein each scenario is designed to measure a specific behavior pattern which represents a cognitive or physical functionality;
C. Fuzzy logic clustering application wherein the fuzzy sets represent characteristics of subject mental state and the predetermined fuzzy rules represent correlations between human behavior and human mental state, wherein said correlation is based on hierarchical brain structure connectivity functionality model;
D. Sensory measurement means for detecting subject reactions to displayed scenarios;
E. Data records files for storing detected and measured reactions;
F. Classification module for organizing recorded measurements in relation to tested behavior according to predefined categories of the fuzzy logic application;
G. Transformation module for translating measurement result values into fuzzy logic parameters scales;
H. Designated fuzzy logic module for calculating fuzzy sets values by applying the fuzzy rules on the measured parameters and creating diagnostically profiles as results;

17. The system of claim 16 wherein the virtual scenarios examine cognitive mental functions by testing sensor-motor abilities in various levels;

18. The system of claim 16 wherein the sensor-motor levels include immediate sensory-motor coordination (such as a ping pong game), integrative sensor-motor ability (such as a maze game), auditory-visual integration (such as an audio-visual matching game).

19. The system of claim 16 wherein the virtual scenarios include environment organization tests for estimating the subject's sensitivity to order;

20. The system of claim 16 wherein the virtual scenarios include interpersonal behavior tests for assessing subject behavior within social activities wherein each social activity measures different level of social interaction;

21. The system of claim 20 wherein the social virtual scenarios include virtual a house containing various kinds of rooms, wherein in each room a different type of specific psychosocial event is taking place, and the subject can choose between the rooms and take part in the social activity;

22. The system of claim 21 wherein the psychosocial activity is differentiated according to different levels of social interactivity and favorability between extremes of pleasant accepting environment and violent aggressive environment.

23. The system of claim 21 wherein the subject is forced to take part in one of the rooms' social activity.

24. The system of claim 16 wherein the virtual scenarios include a combination of sensor motor behavior tests, environment organization tests for estimating subject sensitivity to order, and interpersonal behavior tests for examining subject behavior.

25. The system of claim 16 further comprising of measuring means for testing various physiological conditions (state) of the subject;

26. The system of claim 16 wherein the measurement results are manipulated and converted to correspond with predefined parameters scales.

27. The system of claim 16 further comprising of visual graphic module for creating graphic representation of the created diagnosis profiles;

28. The system of claim 16 wherein the representation graph is multi-dimensional wherein one dimension represents integrative brain functionality, a second dimension represents general level of activity, a third dimension represents general level of activity, a fourth dimension represents risk behavior and attraction/rejection modes, and a fifth dimension represents frustration levels and tolerance;

29. The system of claim 16 further comprising of an analytical module for comparing the diagnostics profiles to reference profiles of specific mental disorders.

30. The system of claim 28 further comprising of a statistical analysis module for deducing the references diagnostic profiles based on subjects historic profiles and final/actual diagnostics.

31. The system of claim 16 wherein the virtual reality equipment includes a head mounted display navigation device and sensors.
